(19) United States
(12) Patent Application Publication
(10) Pub. No.: US 2026/0197099 A1
(43) Pub. Date: Jul. 9, 2026

(54) RADIO FREQUENCY FRONT END MODULE WITH GAIN AND PHASE ALIGNMENT

(71) Applicant: Qorvo US, Inc., Greensboro, NC (US)

(72) Inventor: David Corman, Gilbert, AZ (US)

(21) Appl. No.: 19/411,580

(22) Filed: Dec. 8, 2025

Related U.S. Application Data
(60) Provisional application No. 63/743,303, filed on Jan. 9, 2025.

(51) Int. Cl. H04B 17/13

(52) U.S. Cl. CPC H04B 17/13

(57) ABSTRACT

A radio frequency (RF) front-end module (FEM) includes an amplifier and an integrated circuit coupled to the amplifier. The integrated circuit includes a buffer amplifier coupled to the amplifier, a variable attenuator coupled to the buffer amplifier, a phase shifter or time delayer coupled to the buffer amplifier, and a memory configured to store a gain calibration value and a phase calibration value. The gain calibration value controls an attenuation of the variable attenuator and the phase calibration value controls a phase shift of the phase shifter or a time delay of the first time delayer. The RF FEM also includes an interface configured to store the gain calibration value and the phase calibration value in the memory, an RF connection to a transceiver, and an RF connection to an antenna.

### CROSS-REFERNCE TO RELATED APPLICATIONS

This application claims the priority benefit of U.S. Provisional Patent Application No. 63/743,303, filed January 9, 2025, which is hereby expressly incorporated by reference in its entirety as though fully set forth herein.

### TECHNICAL FIELD

The subject matter described herein relates to devices, methods, and systems for providing on-board calibration for radio frequency (RF) front end modules. This calibrated front-end module has particular but not exclusive utility for power combiners and phased-array beamforming systems.

### BACKGROUND

Gallium arsenide (GaAs), Gallium nitride (GaN), and similar semiconductor radio frequency (RF) components exhibit significant S21 thru-gain and thru-phase part-to-part process variation. N-way power combiners need to sum power from devices that are matched in gain and phase. Power combiners rely on coherent input signals for best output power, yield, and direct current (DC) efficiency. Coherent inputs are ideally at the same signal level and the same phase for optimum power combining. To do this, manufacturers typically “bin” devices that are matched in gain and phase. This can be an expensive, time-consuming, and cumbersome procedure requiring added device-level testing and production control (to group and maintain matched parts).

Phased array antennas also require devices at each antenna element that are matched in gain and phase (or time delay). Dissimilar parts across an array lead to poor beam quality, poor aperture efficiency, and degraded sidelobe performance. In order to match dissimilar parts across an array, extensive array level calibration is employed, where each channel in the array is measured for gain and phase performance. Gain and phase offsets are then calculated and stored in array-level look-up tables that apply unique offsets to each channel’s gain and phase. This calibration is an expensive process adding significant test cost to the phased array antenna, especially for large arrays with many channels that need to be calibrated.

Accordingly, a need exists for improved RF front-end modules that address the forgoing and other concerns.

The information included in this Background section of the specification, including any references cited herein and any description or discussion thereof, is included for technical reference purposes only and is not to be regarded as subject matter by which the scope of the disclosure is to be bound.

### SUMMARY

Disclosed is a calibrated front-end module that integrates a silicon controller IC directly into the front end modules (FEM) to gain match and phase match the FEM to a “golden standard” gain and phase. In this fashion, each FEM acts the same, and the above-mentioned calibration and binning issues may be avoided. Test and calibration time may be reduced or eliminated. No binning of like FEMs may be required since all FEMs are matched to a gain/phase standard. Well-matched devices in an N-way power combiner may result in higher yield, higher RF output power, and higher direct current (DC) efficiency. Well-matched devices in phased array antennas may result in improved beam quality and lower sidelobe levels.

The calibrated front-end module disclosed herein has particular, but not exclusive, utility for power combiners and phased-array antennas. One general aspect includes a radio frequency (RF) front-end module (FEM). The RF FEM includes a first amplifier and an integrated circuit coupled to the first amplifier. The integrated circuit may include a first buffer amplifier coupled to the first amplifier; a first variable attenuator coupled to the first buffer amplifier; a first phase shifter or time delayer coupled to the first buffer amplifier; and a first memory configured to store a gain calibration value and a phase calibration value, where the first gain calibration value controls an attenuation of the first variable attenuator and the first phase calibration value controls a phase shift of the first phase shifter or a time delay of the first time delayer. The RF FEM also includes a first interface configured to store the gain calibration value and the phase calibration value in the first memory; an rf connection to a transceiver, and an rf connection to an antenna. Other embodiments of this aspect include corresponding computer systems, apparatus, and computer programs recorded on one or more computer storage devices, each configured to perform the actions of the methods.

Implementations may include one or more of the following features. In some embodiments, the first amplifier is a gallium arsenide or gallium nitride high-power amplifier. In some embodiments, the first amplifier is a gallium arsenide or gallium nitride low-noise amplifier. In some embodiments, the RF FEM is configured for use in a power combiner. In some embodiments, The RF FEM is configured for use in a phased-array antenna. In some embodiments, the first gain calibration value is established such that a combined gain of the integrated circuit and the first amplifier is substantially equal to the first desired gain, and where the first phase calibration value is established such that a combined phase of the integrated circuit and the first amplifier is substantially equal to the first desired phase. In some embodiments, the RF FEM has a lower standard deviation of gain and a lower standard deviation of phase or time than a FEM that does not include the integrated circuit. In some embodiments, the lower standard deviation of gain and the lower standard deviation of phase or time reduce a need for binning of FEMs or array-level calibration of a phased-array antenna. In some embodiments, the RF FEM may include a temperature sensor coupled to a second variable attenuator, such that a temperature of the RF FEM controls an attenuation of the second variable attenuator. In some embodiments, the first amplifier is disposed on the circuit board; a second amplifier is disposed on the circuit board; and a transmit/receive switch selectably connects the RF connection to the transceiver and the RF connection to the antenna through either the first amplifier or the second amplifier, where the integrated circuit further may include: a second buffer amplifier coupled to the second amplifier; a second variable attenuator coupled to the second buffer amplifier; a second phase shifter or time delayer coupled to the second buffer amplifier; and a second memory configured to store a second gain calibration value and a second phase calibration value, where the second gain calibration value controls an attenuation of the second variable attenuator and the second phase calibration value controls a phase shift of the second phase shifter or a time delay of second first time delayer, where the second gain calibration value is established such that a second combined gain of the integrated circuit and the second amplifier is substantially a second desired gain, where the second phase calibration value is established such that a second combined phase of the integrated circuit and the second amplifier is substantially a second desired phase. Implementations of the described techniques may include hardware, a method or process, or computer software on a computer-accessible medium.

One general aspect includes a phased array antenna or power combiner. The phased array antenna or power combiner includes a radio frequency (RF) front-end module (FEM) that includes: a first amplifier and an integrated circuit coupled to the first amplifier. The integrated circuit may include: a first buffer amplifier coupled to the first amplifier; a first variable attenuator coupled to the first buffer amplifier; a first phase shifter or time delayer coupled to the first buffer amplifier; a first memory configured to store a first gain calibration value and a first phase calibration value, where the first gain calibration value controls an attenuation of the first variable attenuator and the first phase calibration value controls a phase shift of the first phase shifter or a time delay of the first time delayer. The phased array antenna or power combiner also includes a first interface configured to receive a command to set the gain calibration value and the phase calibration value in the first memory; an RF connection to a transceiver, and an RF connection to an antenna. Other embodiments of this aspect include corresponding computer systems, apparatus, and computer programs recorded on one or more computer storage devices, each configured to perform the actions of the methods.

Implementations may include one or more of the following features. The phased array antenna or power combiner may include a second interface configured to set a first desired gain and a first desired phase, where the first gain calibration value is established such that a combined gain of the integrated circuit and the first amplifier is substantially the first desired gain, and where the first phase calibration value is established such that a combined phase of the integrated circuit and the first amplifier is substantially the first desired phase. In some embodiments, the first amplifier is a gallium arsenide or gallium nitride amplifier high-power amplifier or a gallium arsenide or gallium nitride amplifier low-noise amplifier. In some embodiments, the RF fem has a lower standard deviation of gain and a lower standard deviation of phase or time than a FEM that does not include the integrated circuit. In some embodiments, the lower standard deviation of gain and the lower standard deviation of phase or time reduce a need for binning of FEMs or array-level calibration. In some embodiments, the first amplifier is disposed on the circuit board; a second amplifier disposed on the circuit board; and a transmit/receive switch selectably connects the RF connection to the transceiver and the RF connection to the antenna through either the first amplifier or the second amplifier, where the integrated circuit further may include: a second buffer amplifier coupled to the second amplifier; a second variable attenuator coupled to the second buffer amplifier; a second phase shifter or time delayer coupled to the second buffer amplifier; and a second memory storing a second gain calibration value and a second phase calibration value, where the second gain calibration value controls an attenuation of the second variable attenuator and the second phase calibration value controls a phase shift of the second phase shifter or a time delay of second first time delayer, where the second gain calibration value is established such that a second combined gain of the integrated circuit and the second amplifier is substantially a second desired gain, and where the second phase calibration value is established such that a second combined phase of the integrated circuit and the second amplifier is substantially a second desired phase. Implementations of the described techniques may include hardware, a method or process, or computer software on a computer-accessible medium.

One general aspect includes a method. The method includes providing a radio frequency (RF) front-end module (FEM), that includes: a package or housing, a circuit board disposed within the package or housing, a first amplifier disposed on the circuit board, a silicon integrated circuit disposed on the circuit board that may include: a first buffer amplifier coupled to the first amplifier, a first variable attenuator coupled to the first buffer amplifier, a first phase shifter or time delayer coupled to the first buffer amplifier, and a first memory. The method also includes providing an RF connection to a transceiver; and an RF connection to an antenna. The method also includes, with a first serial parallel interface (SPI) disposed on the silicon integrated circuit, controlling a commanded gain and commanded phase or time of the RF FEM. The method also includes, with a measuring device, measuring an output gain and an output phase or time of the RF FEM. The method also includes, with a first one-time programming (OTP) interface disposed on the silicon integrated circuit, based on the commanded gain and commanded phase or time and the output gain and output phase or time, storing into the first memory: a first gain calibration value and a first phase calibration value, where the first gain calibration value controls an attenuation of the first variable attenuator and the first phase calibration value controls a phase shift of the first phase shifter or a time delay of the first time delayer, where the first gain calibration value is based on the output gain, and where the first phase calibration value is based on the output phase or time. Other embodiments of this aspect include corresponding computer systems, apparatus, and computer programs recorded on one or more computer storage devices, each configured to perform the actions of the methods.

Implementations may include one or more of the following features. In some embodiments, the first amplifier is a gallium arsenide or gallium nitride high-power amplifier. In some embodiments, the first amplifier is a gallium arsenide or gallium nitride low-noise amplifier. In some embodiments, the silicon integrated circuit further may include: a second buffer amplifier coupled to the second amplifier; a second variable attenuator coupled to the second buffer amplifier; a second phase shifter or time delayer coupled to the second buffer amplifier; and a second memory; and with a second serial parallel interface (SPI) disposed on the silicon integrated circuit, controlling a second commanded gain and second commanded phase or time of the RF FEM; with a second measuring device, measuring a second output gain and second output phase or time of the RF FEM; and with a second one-time programming (OTP) interface disposed on the silicon integrated circuit, based on the second commanded gain and second commanded phase or time and the second output gain and second output phase or time, storing into the second memory: a second gain calibration value and a second phase calibration value, where the second gain calibration value controls an attenuation of the second variable attenuator and the second phase calibration value controls a phase shift of the second phase shifter or a time delay of the second time delayer, where the second gain calibration value is based on the second output gain, and where the second phase calibration value is based on the second output phase or time. Implementations of the described techniques may include hardware, a method or process, or computer software on a computer-accessible medium.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the calibrated front-end module, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is an exemplary representation, in block diagram form, of a gain/phase calibration integrated circuit, in accordance with at least one embodiment of the present disclosure.

FIG. 2 is a schematic, diagrammatic representation, in block diagram form, of an example transmit-mode calibrated front-end module (FEM), in accordance with at least one embodiment of the present disclosure.

FIG. 3 is a schematic, diagrammatic representation, in block diagram form, of an example receive-mode calibrated front-end module (FEM), in accordance with at least one embodiment of the present disclosure.

FIG. 4 is a schematic, diagrammatic representation, in block diagram form, of an example time division duplexing (TDD) mode calibrated front-end module (FEM), in accordance with at least one embodiment of the present disclosure.

FIG. 5 is a schematic, diagrammatic representation, in block diagram form, of an example calibrated front end module, in accordance with at least one embodiment of the present disclosure.

FIG. 6 is a schematic, diagrammatic representation, in block diagram form, of an example time division duplexing (TDD) calibrated mode front-end module (FEM), in accordance with at least one embodiment of the present disclosure.

FIG. 7 is a schematic, diagrammatic representation of an example time division duplexing (TDD) calibrated mode front-end module (FEM) package, in accordance with at least one embodiment of the present disclosure.

FIG. 8 is a diagrammatic representation of advantages of the calibrated front-end module in a 16:1 power combiner application, in accordance with at least one embodiment of the present disclosure.

FIG. 9 is a diagrammatic representation of advantages of the calibrated front-end module in a 16:1 power combiner application, in accordance with at least one embodiment of the present disclosure.

FIG. 10 is a diagrammatic representation of advantages of the calibrated front-end module in a phased array application at a frequency of 28.00 gigahertz, in accordance with at least one embodiment of the present disclosure.

FIG. 11 shows a flow diagram of an example front-end module calibration method, in accordance with at least one embodiment of the present disclosure.

FIG. 12 is a schematic diagram of a processor circuit, in accordance with at least one embodiment of the present disclosure.

### DETAILED DESCRIPTION

In accordance with at least one embodiment of the present disclosure, a calibrated front-end module is provided which integrates silicon controller ICs directly into front end modules (FEMs) to provide gain and phase matching of the FEMs to a golden standard. The golden standard may be arbitrary and hardware-dependent, but may for example include a target phase of 0 degrees and target gain of 20 dB. In this fashion, each FEM acts approximately the same as other FEMs of the same type, and the above-mentioned calibration and binning issues may thus be avoided or greatly reduced. Test and calibration time may be reduced or eliminated. No binning of like FEMs may be required, since all FEMs are matched to a golden gain/phase standard. Well-matched devices in an N-way power combiner may result in higher yield, higher RF output power, and higher DC efficiency. Well-matched devices in phased array antennas may result in improved beam quality and lower sidelobe levels. This may be of significant value to RF device manufacturers who want to improve their product cost while reducing manufacturing cost and time to market.

Elements of the calibrated front-end module may include, but are not limited to, input/output buffer amplifiers, a silicon controller with RF gain/phase control, a digital control interface, and digital addition capability that includes the ability to fuse (one time program) corrections for gain/phase errors measured in the associated FEM. This technology may be applied to front end modules with any combination of the following: a high power amplifier, a low noise amplifier, a transmit/receive switch, and an RF limiter.

A serial parallel interface (SPI) can be employed to control the gain and phase of individual RF channels in a silicon integrated circuit (IC). During production test of each FEM an alignment procedure is conducted wherein the gain and phase of each RF channel within the FEM is measured, and then a digital offset is calculated for each of the gain and the phase that, when added to the commanded (intended or golden standard) gain and phase setting of that channel, matches that RF channel to the commanded values. This digital offset is then burned into the IC using one-time programming (OTP). The host system can then command gain and phase of the FEM without needing to know the internal correction applied to each RF channel. Similarly after the FEM has been calibrated for gain and phase, the FEM can be used in the host system without further gain and phase commands but with the host system benefiting from all FEMs exhibiting similar gain and phase performance.

In an example, a small silicon (Si) controller IC is placed inside a packaged FEM. The Si controller may include the following features: gain/phase control, output buffer amplifier to drive an HPA, input buffer amplifier after an LNA to preserve Rx noise figure, an optional input buffer amplifier to preserve Tx noise figure, a digital control interface, and a digital offset OTP.

For power combiners, the calibrated front-end module avoids binning of amplifiers for gain/phase matching, reduces test and manufacturing cost and management of multiple binned devices, and optimizes coherent power combining, leading to lower test costs and improved output power, DC efficiency, and RF yield, and thus lowers product cost. For phased array antennas, the calibrated front-end module reduces array level calibration and test time, improves beam quality and sidelobe levels, and thus lowers product cost. In some implementations, the calibrated front-end module can include temperature compensation of high-power amplifier/low-noise amplifier (HPA/LNA) gain in the Si controller, such that the Si IC will provide substantially constant gain over temperature by adding a suitable temperature sensor and variable attenuator.

The present disclosure aids substantially in the production of RF power combiners and phased-array systems, by improving the gain and phase consistency of RF front-end modules. Implemented with a silicon chip integrated directly into the front-end module package, the calibrated front-end module disclosed herein provides practical reduction in the standard deviations of gain and phase for semiconductor RF amplifiers. This improved consistency transforms a power combiner sub-optimal power output or a phased-array antenna with suboptimal beam steering into one that approaches theoretical ideals, without the normally routine need to bin components by their gain/phase properties, or to provide array-level calibration for phased-array antenna systems. This unconventional approach improves the functioning of the RF transmitter or receiver, by reducing or eliminating losses due to poor coherence, thus improving efficiency and/or reducing energy consumption and the greenhouse gas emissions associated therewith.

These descriptions are provided for exemplary purposes only, and should not be considered to limit the scope of the calibrated front-end module. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

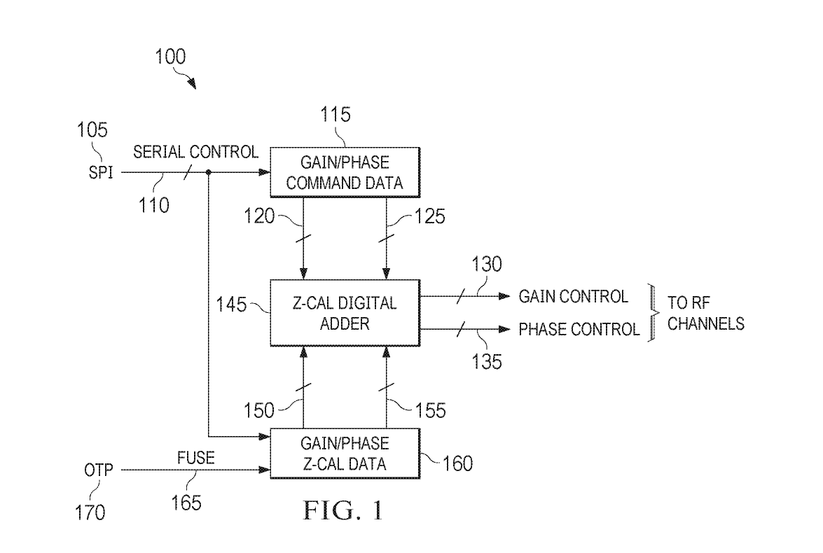

FIG. 1 is an exemplary representation, in block diagram form, of a gain/phase calibration integrated circuit 100, in accordance with at least one embodiment of the present disclosure. The gain/phase calibration integrated circuit includes a serial parallel interface (SPI) 105 providing serial control 110 to a gain/phase command 115, which provides an uncorrected gain control signal 120 and an uncorrected phase control signal 125 to a digital adder 145. A one-time programming (OTP) interface 170 selectively burns fuses 165 in a digital offset non-volatile memory 160, which provides a gain correction value 150 and a phase correction value 155 to the digital adder 145. The digital adder then adds the gain correction value 150 to the uncorrected gain control signal 120 to output a corrected gain control signal 130, and adds the phase correction 155 to the uncorrected phase control signal 125, to output a corrected phase control signal 135. In this way, both the gain and the phase may be corrected such that the actual output of an RF circuit matches “gold standard” gain and phase values (which may for example be equal to the commanded values). In an example, the SPI 105 loads the target gain and phase from the host system, but the SPI 105 also loads the correction gain/phase data (during IC production test) which is then latched into non-volatile memory using the OTP controls 170.

The SPI interface 105 is thus employed to control the gain and phase of individual RF channels in a silicon IC, with the host system supplying the commands. The alignment procedure involved measuring the gain and phase of each RF channel, and then calculating a digital offset 160 for the gain and phase that, when added to the commanded or intended gain and phase setting for that channel, matches that RF channel to the “gold standard” value (e.g., the commanded or intended gain and phase). This digital offset is then burned into the IC using the OTP interface 170. The host system then can continue to command the gain and phase without needing to know the internal correction applied to each RF channel. One disadvantage of this setup is that each channel must be calibrated independently, which can add time and cost to the process of assembling and testing RF systems. It is therefore advantageous to incorporate the silicon controller directly into a front-end module, which can be calibrated at the time of manufacture and then sold to an RF system developer, with much lower part-to-part variance on the gain and phase for the front-end modules.

Block diagrams are provided herein for exemplary purposes; a person of ordinary skill in the art will recognize myriad variations that nonetheless fall within the scope of the present disclosure. Block diagrams may show a particular arrangement of components, modules, services, steps, processes, or layers, resulting in a particular data, power, or signal flow. It is understood that some embodiments of the systems disclosed herein may include additional components, that some components shown may be absent from some embodiments, and that the arrangement of components may be different than shown, resulting in different data, power, or signal flows while still performing the methods described herein.

Before continuing, it should be noted that the examples described above are provided for purposes of illustration, and are not intended to be limiting. Other devices and/or device configurations may be utilized to carry out the operations described herein.

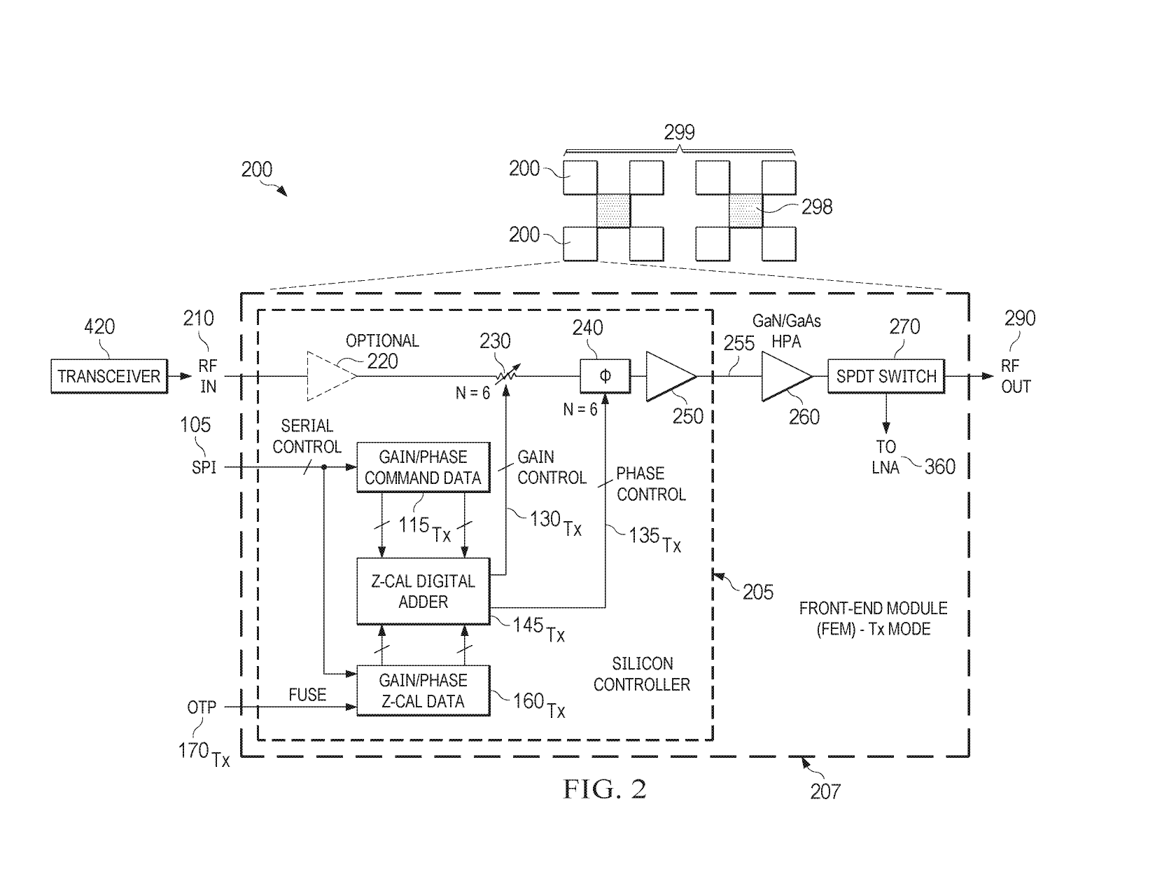

FIG. 2 is a schematic, diagrammatic representation, in block diagram form, of an example transmit-mode calibrated front-end module (FEM) 200, in accordance with at least one embodiment of the present disclosure. The transmit-mode calibrated FEM 200 includes a silicon controller 205 and a circuit board 207.

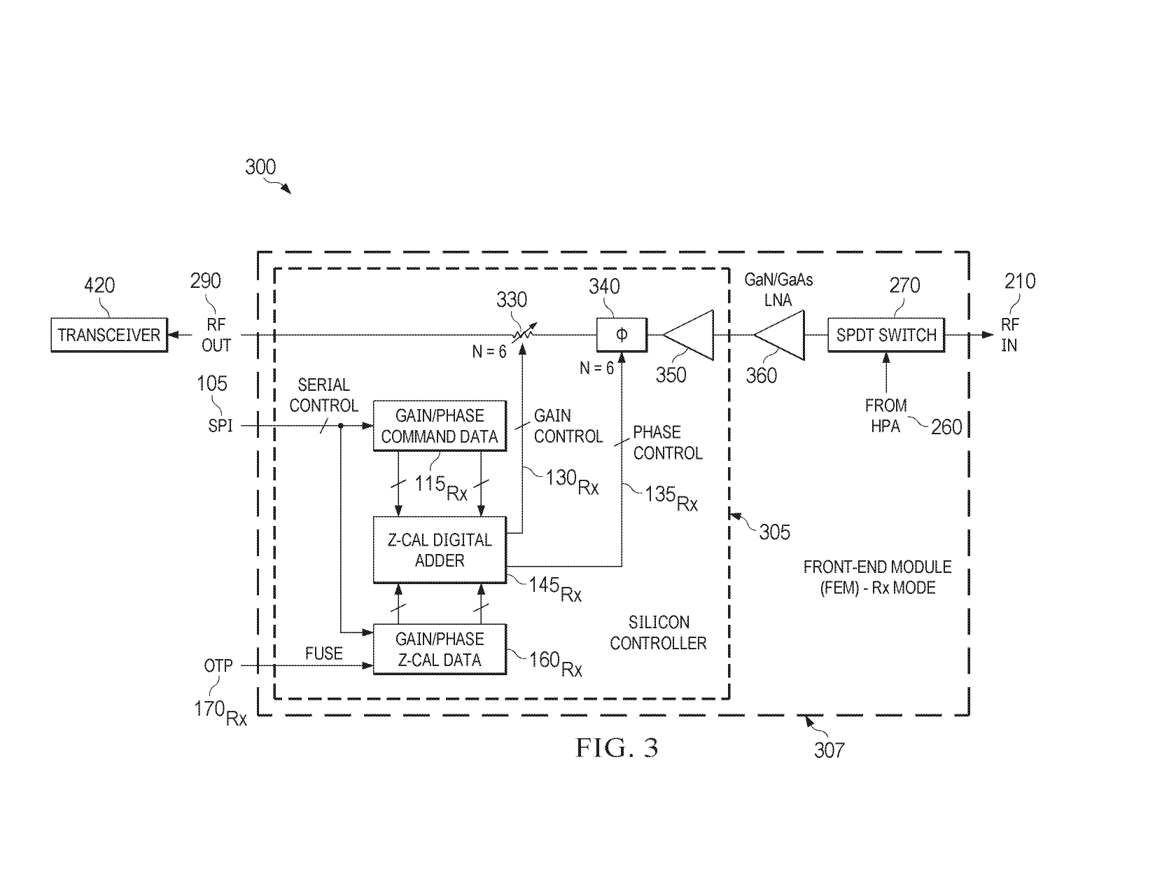

The silicon controller 205 includes an SPI 105, gain/phase command data 115_{Tx}, a digital adder 145_{Tx}, an OTP interface 170_{Tx}, and gain/phase correction data 160_{Tx}. A corrected gain control signal 130_{Tx} controls a variable resistor or attenuator 230. A corrected phase control signal 135_{Tx} controls a phase shifter 240. In this context, N=6 denotes the number of gain and phase bits used in the correction algorithm. It may be an arbitrary number, wherein higher values offer finer trim of gain and phase. When an RF In signal 210 is received by the FEM 200 (e.g., from a transceiver 420), it passes into the silicon controller 205, through an optional amplifier 220, the variable resistor or attenuator 230, the phase shifter 240, and a buffer amplifier 250, before being received by the circuit board 207. Thus, the circuit board receives only the gain-corrected and phase-corrected RF In signal 255. The corrected signal 255 is then received by a high-power amplifier (HPA) 260 for amplification, and then passes through a single-pole, double-throw (SPDT) transmit/receive (T/R) switch 270, which either routes the corrected signal 255 to an RF Out line 290 (e.g., output to the antenna), or routes input signals from the antenna to a low-noise amplifier 360, as shown below in FIG. 3. The configuration shown in FIG. 2 may for example be useful in phased-array antenna applications.

In a non-limiting example, four front-end modules 200 may be used to control a beam-forming integrated circuit (BFIC) 298 in a phased-array antenna 299.

The Si-only gain/phase alignment procedure described above in FIG. 1 can be extended to a multi-IC configuration where a silicon control IC 205 with gain/phase digital offset capability is driving a high-power amplifier (HPA) 260 realized in GaAs, GaN, or other suitable technology. The output of the Si/HPA cascade is measured and then a digital offset is calculated and stored in the silicon IC, such that the Si/HPA cascaded gain and phase is matched to a “gold standard” value.

In other words, the combined gain of the integrated circuit and the high-power amplifier is the desired gain, and the combined phase of the integrated circuit and the high-power amplifier is the desired phase.

FIG. 3 is a schematic, diagrammatic representation, in block diagram form, of an example Receive-mode calibrated front-end module (FEM) 300, in accordance with at least one embodiment of the present disclosure. The receive-mode FEM 300 includes a silicon controller 305 and a circuit board 307.

The silicon controller 305 includes an SPI 105, gain/phase command data 115_{Rx}, a digital adder 145_{Rx}, an OTP interface 170_{Rx}, and gain/phase correction data 160_{Rx}. A corrected gain control signal 130_{Rx} controls a variable resistor or attenuator 330. A corrected phase control signal 135_{Rx} controls a phase shifter 340. In this context, N=6 denotes the number of gain and phase bits used in the correction algorithm. When an RF In signal 210 is received by the FEM 300 (e.g., from the antenna), it passes into the circuit board 307, where it passes through a single-pole, double-throw (SPDT) transmit/receive (T/R) switch 270, which either connects the high-power amplifier 260 to the antenna for transmission, or routes input signals from the antenna to a low-noise amplifier 360 for amplification. The amplified signal then passes into the silicon controller 305, then through a buffer amplifier 350, the phase shifter 340, and the variable resistor or attenuator 330, before being passed to an RF out line 290 (e.g., to the transceiver 420). Thus, the transceiver receives only the gain-corrected and phase-corrected RF Out signal 290. The configuration shown in FIG. 3 may for example be useful in phased-array antenna applications.

The Si-only gain/phase alignment procedure described above can be extended to a multi-IC configuration where a silicon control IC 305 with gain/phase digital offset capability is following a low-noise amplifier (LNA) 360 realized in GaAs, GaN, or other suitable technology. The output of the LNA/Si cascade is measured and then a digital offset is calculated and stored in the silicon IC such that the LNA/Si cascaded gain and phase is matched to the “gold standard” value.

In other words, the combined gain of the integrated circuit and the low-noise amplifier is the desired gain, and the combined phase of the integrated circuit and the low-noise amplifier is the desired phase.

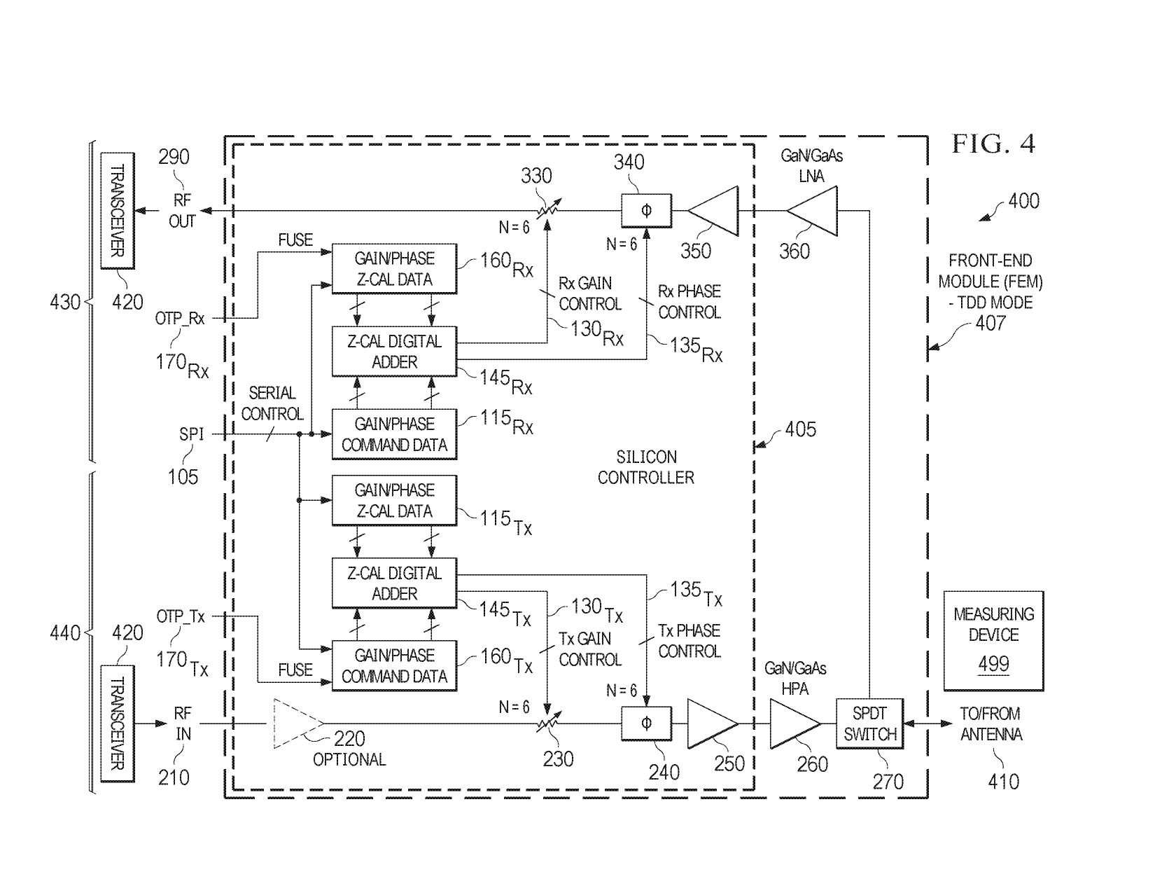

FIG. 4 is a schematic, diagrammatic representation, in block diagram form, of an example time division duplexing (TDD) calibrated mode front-end module (FEM) 400, in accordance with at least one embodiment of the present disclosure. The TDD-mode FEM 400 includes a silicon controller 405 that combines the functions of the silicon controller 205 of FIG. 2 and the silicon controller 305 of FIG. 3. Similarly, the TDD-mode FEM 400 includes a circuit board that combines the functions of the circuit boards 207 of FIG. 2 and 307 of FIG. 3.

Visible are the SPI 105, gain/phase command data 115_{Tx}, digital adder 145_{Tx}, OTP interface 170_{Tx}, gain/phase correction data 160_{Tx}, corrected gain control signal 130_{Tx}, variable resistor or attenuator 230, corrected phase control signal 135_{Tx}, phase shifter 240, optional amplifier 220, buffer amplifier 250, high-power amplifier 260, and transceiver 420, which function as described in FIG. 2.

Also visible are the gain/phase command data 115_{Rx}, digital adder 145_{Rx}, OTP interface 170_{Rx}, gain/phase correction data 160_{Rx}, corrected gain control signal 130_{Rx,} variable resistor or attenuator 330, corrected phase control signal 135_{Rx}, phase shifter 340, buffer amplifier 350, and low-noise amplifier 360, which function as described in FIG. 3.

Also visible is a single-pole, double-throw (SPDT) transmit/receive (T/R) switch 270, which connects the antenna 410 to either the transmit circuitry 440 (as shown and described in FIG. 2) or the receive circuitry 430 (as shown and described in FIG. 3). The configuration shown in FIG. 4 may for example be useful in phased-array antenna applications. The Tx and Rx channels are gain- and phase-aligned independently using the procedure described above.

A measuring device 499 is used to measure the output gain and phase of the front-end module 400, such that proper calibration values can be determined for both the receive and transmit signal paths. The measurement device 499 may for example be a vector network analyzer capable of measuring absolute gain and absolute phase, although other measurement devices, as would occur to a person of ordinary skill in the art, may be used instead or in addition. In some implementations, the measurement device 499 may be part of or integrated with the host system.

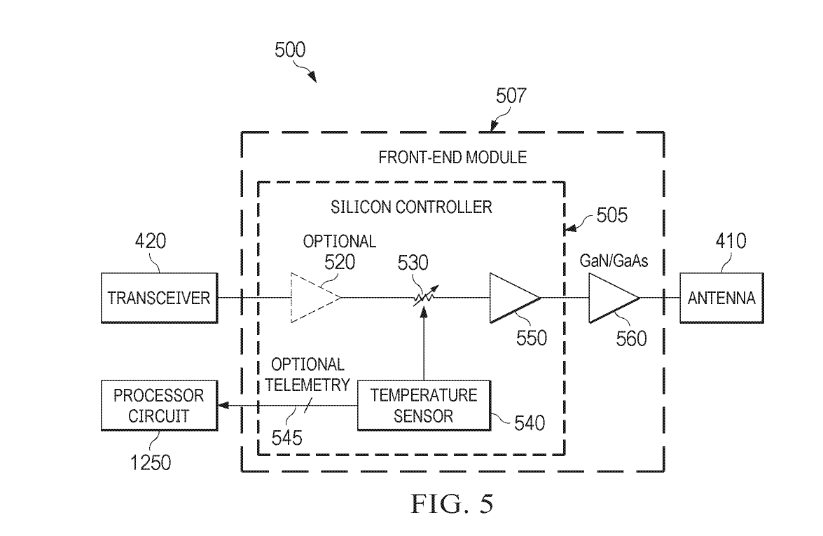

FIG. 5 is a schematic, diagrammatic representation, in block diagram form, of an example calibrated front end module 500, in accordance with at least one embodiment of the present disclosure. The front-end module 500 includes both a silicon controller 505 and a circuit board 507. The silicon controller 505 includes a temperature sensor 540 that controls a variable resistor or attenuator 530, as well as an output amplifier 550 and optional input amplifier 520. In some embodiments, the temperature sensor 540 sends an optional telemetry signal 545 (e.g., a temperature reading) to, for example, a processor circuit 1250 of the host system, for display or storage. The circuit board includes an amplifier 560 (which may for example be a high-power amplifier or a low-noise amplifier realized in GaAs or GaN, depending on the implementation). As in FIGS. 2-4, the variable resistor or attenuator 530 adjusts the gain of the signal passing between the transceiver and the antenna (or vice-versa), although in the case of FIG. 5, the result is a temperature compensation. This is useful, because GaAs and GaN amplifiers can be temperature-dependent in their gain response.

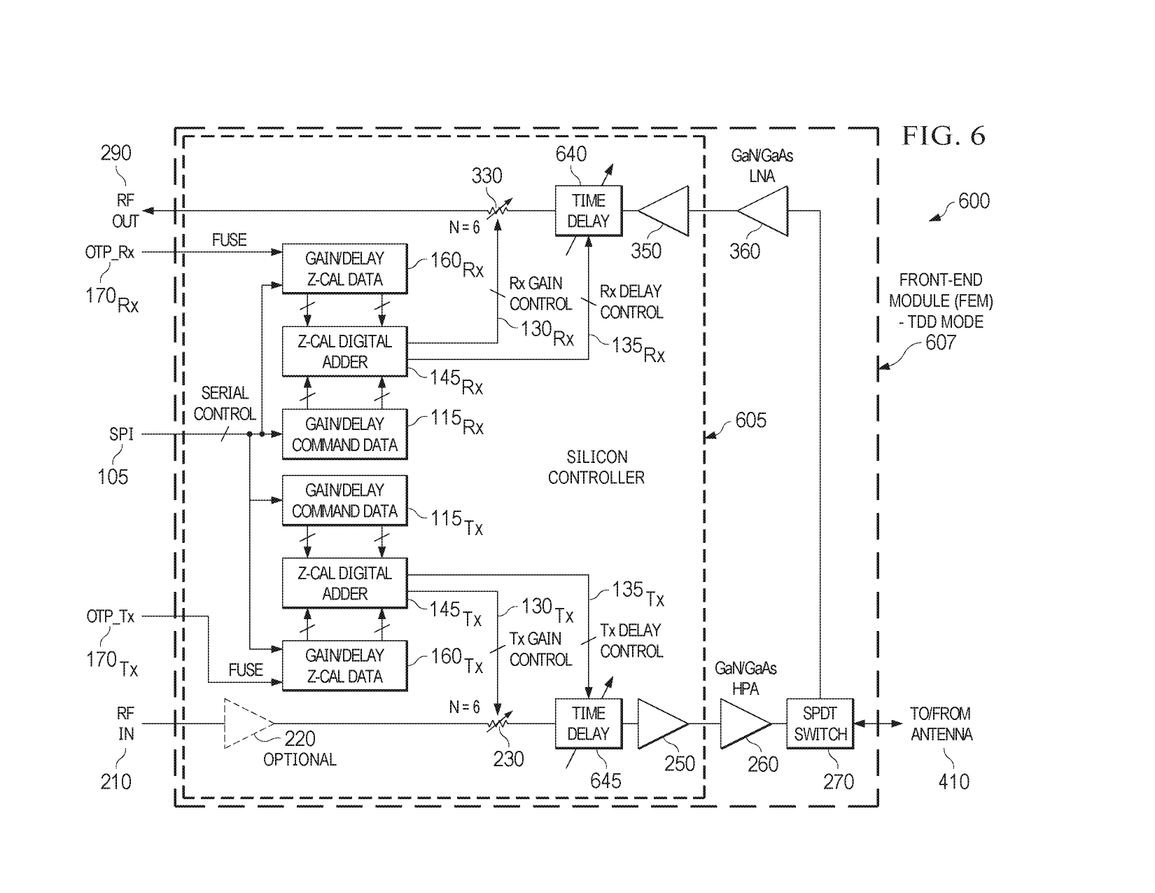

FIG. 6 is a schematic, diagrammatic representation, in block diagram form, of an example time division duplexing (TDD) calibrated mode front -end module (FEM) 600, in accordance with at least one embodiment of the present disclosure. The TDD-mode FEM 600 is similar to the front-end module 400 of FIG. 4, except that the phase shifter 340 has been replaced by a time delay module or time delayer 640, and the phase shifter 240 has been replaced by a time delay module or time delayer 645. By adjusting the time delay instead of the phase, the front-end module 600 can time-synchronize input and output RF signals coming in through different FEMs. The configuration shown in FIG. 6 may for example be useful in broadband or wideband applications such as wideband phased array antennas.

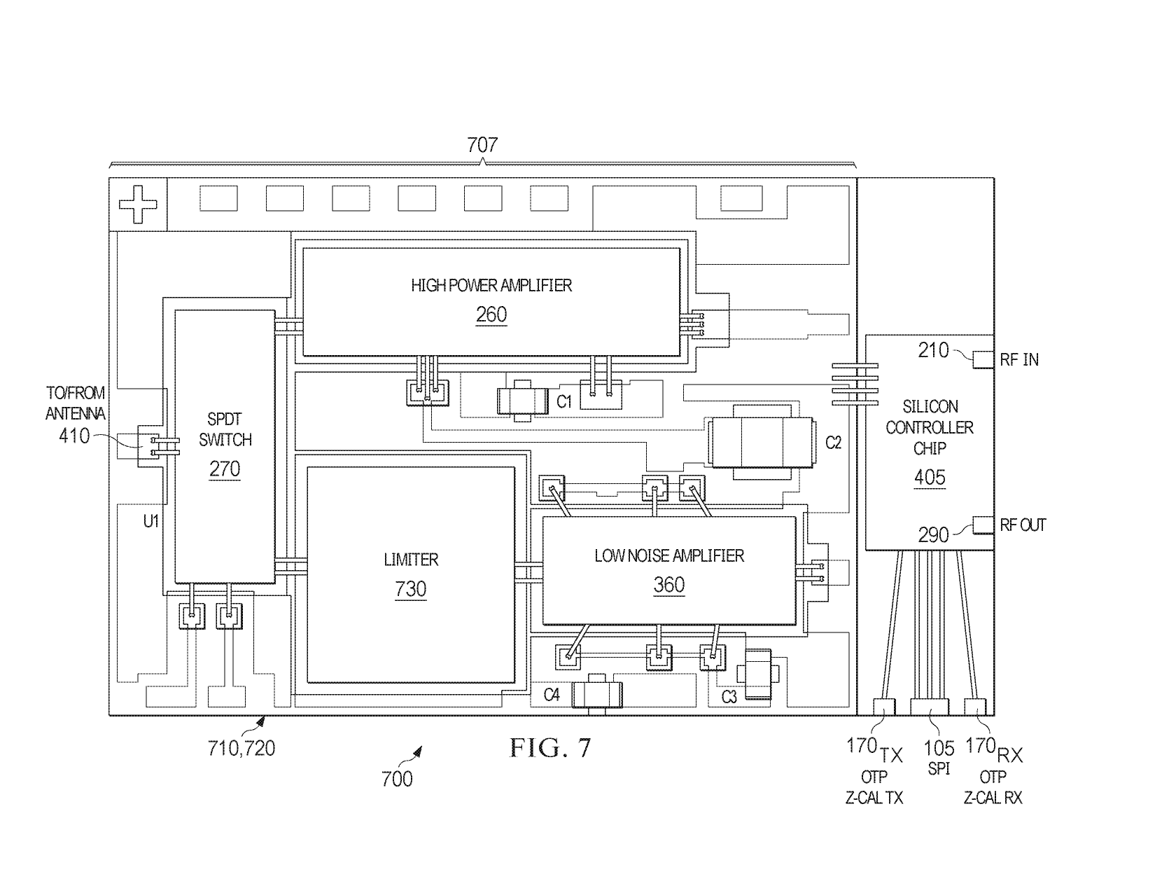

FIG. 7 is a schematic, diagrammatic representation of an example time division duplexing (TDD) calibrated mode front-end module (FEM) package 700, in accordance with at least one embodiment of the present disclosure. The package 700 includes a housing 710 and a circuit board 720, which include a circuit board 707, and a silicon controller chip 405 which functions as described above in FIG. 4 or FIG. 6. The circuit board 707 includes an SPDT T/R switch 270, a connection to the antenna 410, a high-power amplifier 260, a limiter 730, a low-noise amplifier 360, an RF In transceiver connection 210, an RF Out transceiver connection 290, a transmit-mode one-time programming interface 170_{Tx}, a receive mode one-time programming interface 170_{Rx}, and an SPI interface 105 for commanding the desired gain and phase. One advantage of placing the circuit board 707 in the same package with the silicon controller 405 is that the front-end module (FEM) package 700 can serve as a drop-in replacement for uncorrected/uncalibrated FEMs, but can in fact be calibrated at the time of manufacture to a “gold standard” gain and phase, such that RF system manufacturers may not need to perform any further binning or calibration steps. The front-end module (FEM) package 700 thus provides significant advantages to the manufacturers of power combiners and phased-array antennas.

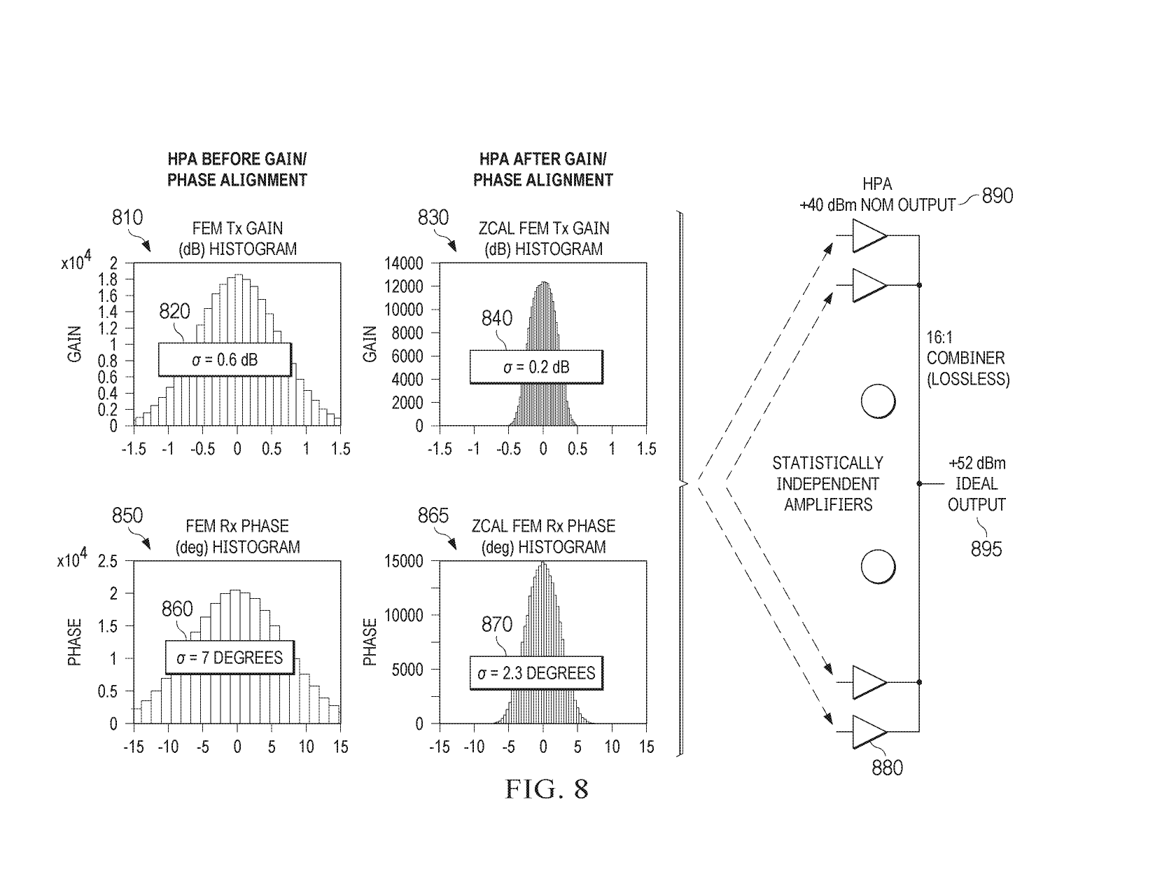

FIG. 8 is a diagrammatic representation of advantages of the calibrated front-end module in a 16:1 power combiner application, in accordance with at least one embodiment of the present disclosure. A histogram 810 shows the distribution of measured gain values for an uncorrected high-power amplifier FEM design, with a standard deviation 820 of 0.6 dB. After gain and phase alignment of the HPA FEM, the gain histogram 830 is much narrower, with a standard deviation of only 0.2 dB – a 66% improvement. Similarly, a histogram 850 shows the distribution of measured phase values for the uncorrected HPA FEM design, with a standard deviation 860 of 7 degrees. After gain and phase alignment of the HPA FEM, the phase histogram 865 is much narrower, with a standard deviation 870 of 2.3 degrees – a 67% improvement. In the example shown in FIG. 8, 16 statistically independent HPA FEMs 880 have a nominal power output 890 of + 40 dBm, and an ideal (e.g., lossless) combined power output 895 of +52 dBm. The aligned gain for all of the measured FEMs is thus substantially equal to the desired gain (e.g., within 0.5 dB), and the aligned phase is substantially equal to the desired phase (e.g., within 7 degrees).

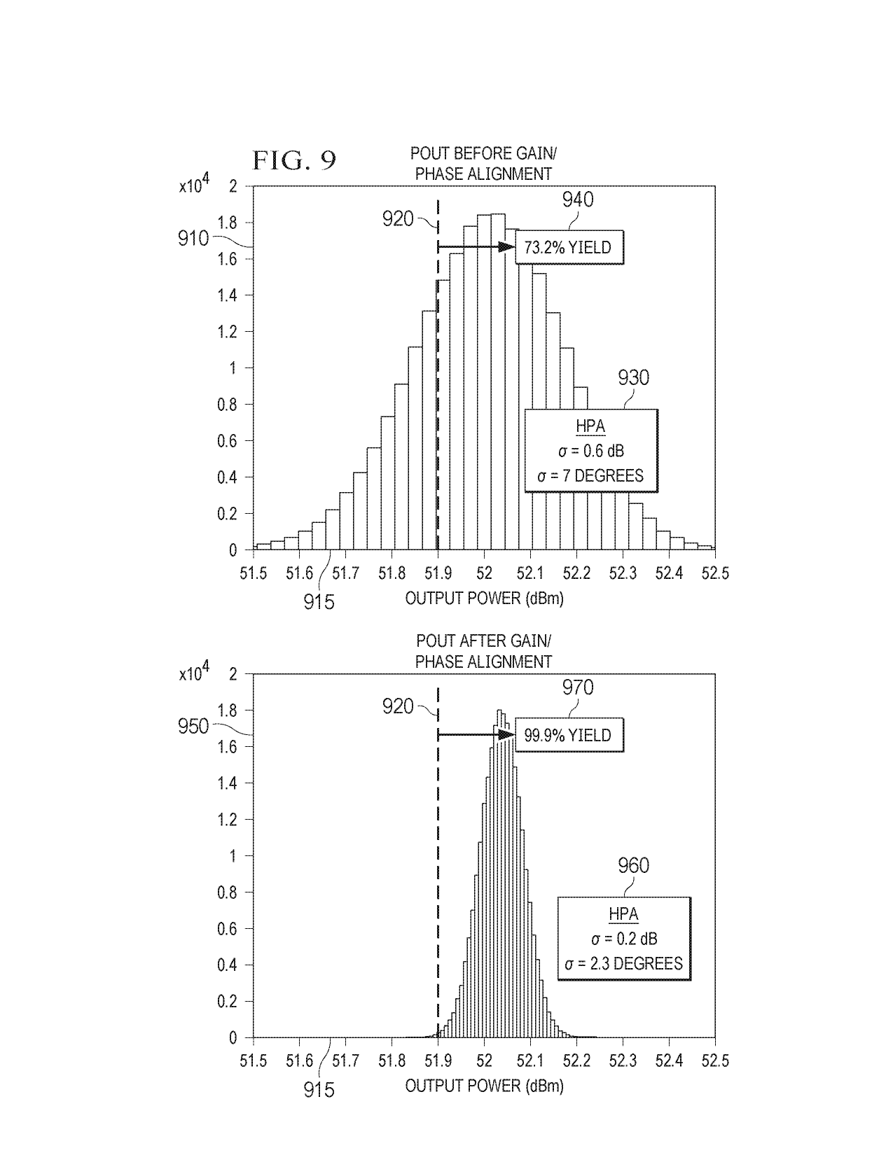

Performance of the power combiner is improved through the use of calibrated front-end modules, as shown below in FIG. 9.

FIG. 9 is a diagrammatic representation of advantages of the calibrated front-end module in a 16:1 power combiner application, in accordance with at least one embodiment of the present disclosure. In the example shown in FIG. 9, a histogram 910 shows the power output 915 of a group of 16:1 power combiners, manufactured with the uncorrected/unaligned front end modules from FIG. 8. The histogram 910 shows standard deviations 930 of 0.6 dB for the gain and 7 degrees for the phase. As can be seen in the histogram 910, approximately 26.8% of the power combiners have a power output 915 that is less than the minimum acceptable power output 920 of 51.9 dBm, resulting in a yield 940 of 73.2%. In other words, 26.8% of the power combiners may need to be discarded as scrap.

However, a histogram 950 shows the power output 915 of a group of 16:1 power combiners, with the front-end modules from FIG. 8 that have undergone gain/phase alignment according to the methods described herein. The histogram 950 shows much smaller standard deviations 960 of 0.2 dB for the gain and 2.3 degrees for the phase. As can be seen in the histogram 950, only approximately 0.1% of the power combiners have a power output 915 of less than the minimum acceptable power output 920 of 51.9 dBm, resulting in a yield 970 of 99.9%. In other words, only 0.1% of the power combiners may need to be discarded as scrap. Thus, the gain/phase alignment may result in a significant cost savings of ~26.7% for the power combiner manufacturer.

It is noted that these histograms were developed using an assumption of zero combining loss due to the 16:1 combiner itself.

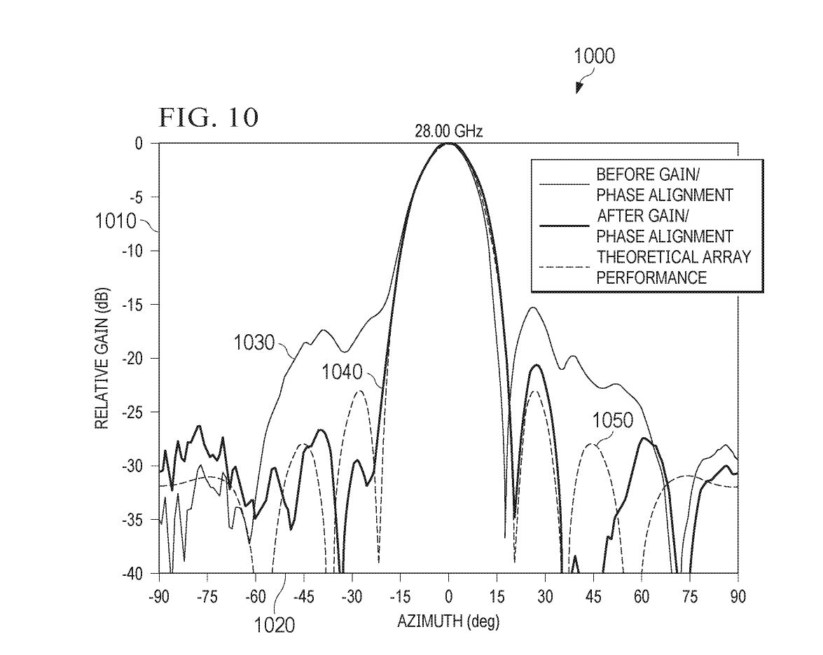

FIG. 10 is a diagrammatic representation of advantages of the calibrated front-end module in a phased array application at a frequency of 28.00 gigahertz, in accordance with at least one embodiment of the present disclosure. A graph 1000 shows antenna relative gain 1010 in decibels vs. azimuth 1020 in degrees. A first curve 1030 shows the performance of a phased array with uncorrected or unaligned front-end modules. As can be seen in the curve 1030, there is significant transmission between ±15 and ±60 degrees azimuth, meaning that the transmitted sidelobe levels are not well controlled.

A second curve 1040 shows the performance of a phased array constructed using front-end modules that have been gain/phase aligned according to the methods described herein. As can be seen in the curve 1040, the gain/phase aligned phased array shows comparable transmission to the curve 1030 between 0 and ±15 degrees azimuth, but much lower transmission between ±15 and ±60 degrees azimuth, indicating that the transmitted sidelobe levels are much better controlled.

A third curve 1050 shows the theoretical performance of the phased array with perfect alignment. As can be seen in the graph 1000, the aligned array 1040 is much closer to the theoretical ideal 1050 than is the unaligned array 1030. Thus, it can be seen that the calibrated front-end module of the present disclosure provides gain/phase alignment of each RF channel in the array, leading to improved beam quality, near-ideal array behavior, and reduced sidelobes.

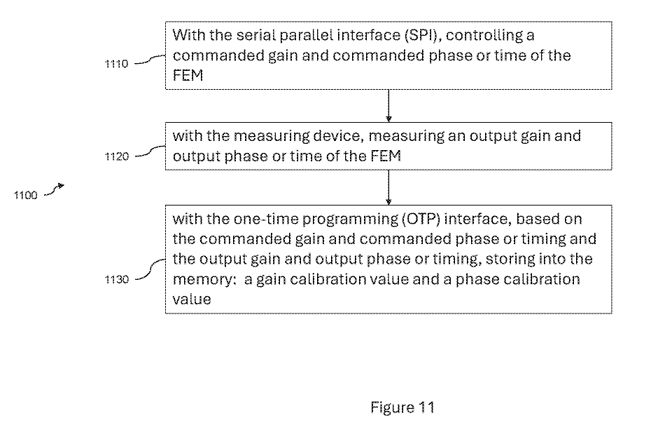

FIG. 11 shows a flow diagram of an example front-end module calibration method, in accordance with at least one embodiment of the present disclosure. It is understood that the steps of method 1100 may be performed in a different order than shown in FIG. 11, additional steps can be provided before, during, and after the steps, and/or some of the steps described can be replaced or eliminated in other embodiments. One or more of steps of the method 1100 can be carried by one or more devices and/or systems described herein, such as components of the system 100, 200, 300, 400, 500, 600 and/or processor circuit 1250.

In step 1110, the method 1100 includes, with the serial parallel interface (SPI), controlling a commanded gain and commanded phase or timing of the FEM output. Execution then proceeds to step 1120.

In step 1120, the method 1100 includes, with a measuring device such as a vector network analyzer, measuring the output gain and output phase or timing of the RF FEM. Execution then proceeds to step 1130.

In step 1130, the method 1100 includes, with the one-time programming (OTP) interface, based on the commanded gain and commanded phase or timing and the output gain and output phase or timing, storing into the first memory:

a gain calibration value and a phase calibration value, where the gain calibration value controls an attenuation of a variable attenuator and the phase calibration value controls a phase shift of a phase shifter or a time delay of a time delay module or time delayer. The method 1100 is now complete.

Flow diagrams are provided herein for exemplary purposes; a person of ordinary skill in the art will recognize myriad variations that nonetheless fall within the scope of the present disclosure. For example, any of the steps described herein may optionally include an output to a user of information relevant to the step, and may thus represent an improvement in the user interface over existing art by providing information (whether static or dynamically updated) that is not otherwise available.

Similarly, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the steps described herein into a plurality of machine instructions, and may execute these instructions at the rate of several hundred, several thousand, several million, or several billion per second, in a single processor or across a plurality of processors. Such rapid execution may be necessary in order to execute the method in real time or near-real time as described herein.

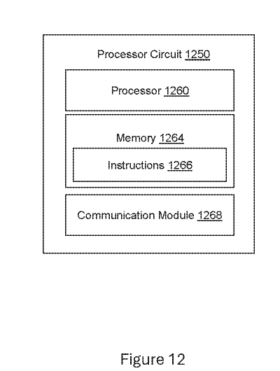

FIG. 12 is a schematic diagram of a processor circuit 1250, in accordance with at least one embodiment of the present disclosure. The processor circuit 1250 may be implemented in the system 100, 200, 300, 400, 500, 600, 700, or other devices or workstations (e.g., third-party workstations, network routers, etc.), or on a cloud processor or other remote processing unit, as necessary to implement the method. As shown, the processor circuit 1250 may include a processor 1260, a memory 1264, and a communication module 1268. These elements may be in direct or indirect communication with each other, for example via one or more buses.

The processor 1260 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 1260 may also comprise another hardware device, a firmware device, or any combination thereof configured to perform the operations described herein. The processor 1260 may also be implemented as a combination of computing devices, e.g., a combination of a DSP and a microprocessor, a plurality of microprocessors, one or more microprocessors in conjunction with a DSP core, or any other such configuration.

The memory 1264 may include a cache memory (e.g., a cache memory of the processor 1260), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 1264 includes a non-transitory computer-readable medium. The memory 1264 may store instructions 1266. The instructions 1266 may include instructions that, when executed by the processor 1260, cause the processor 1260 to perform the operations described herein. Instructions 1266 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 1268 can include any electronic circuitry and/or logic circuitry to facilitate direct or indirect communication of data between the processor circuit 1250, and other processors or devices. In that regard, the communication module 1268 can be an input/output (I/O) device. In some instances, the communication module 1268 facilitates direct or indirect communication between various elements of the processor circuit 1250 and/or the system 100, 200, 300, 400, 500, 600, or 700. The communication module 1268 may communicate within the processor circuit 1250 through numerous methods or protocols. Serial communication protocols may include but are not limited to United States Serial Protocol Interface (US SPI), Inter-Integrated Circuit (I²C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, or calibration readings from an external sensor) may be accomplished using any suitable wireless or wired communication technology, such as a cable interface such as a universal serial bus (USB), micro USB, Lightning, or FireWire interface, Bluetooth, Wi-Fi, ZigBee, Li-Fi, or cellular data connections such as 2G/GSM (global system for mobiles) , 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

As will be readily appreciated by those having ordinary skill in the art after becoming familiar with the teachings herein, the calibrated front-end module advantageously reduces or eliminates the need for binning of FEMs or amplifiers, and reduces or eliminates the need for array-level calibration of phased array antennas. Accordingly, it can be seen that the calibrated front-end module of the present disclosure fills a long-standing need in the art, by providing a means, built right onto the front-end module, to compensate for part-to-part variation in gain, phase, and timing, as well as real-time variations in temperature.

A number of variations are possible on the examples and embodiments described above. For example, the components described herein could be made of other materials than those described. The silicon IC could for example be made of one or more different semiconductors besides or in addition to silicon. The GaAs or GaN components could be made of one or more different semiconductor materials, while still performing the functions described herein. The technology described herein may be applied to communications, remote sensing, or electronic warfare applications.

Accordingly, the logical operations making up the embodiments of the technology described herein are referred to variously as operations, steps, objects, elements, components, or modules. Furthermore, it should be understood that these may occur, or be performed or arranged, in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader’s understanding of the claimed subject matter, and do not create limitations, particularly as to the position, orientation, or use of the calibrated front-end module. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the calibrated front-end module as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A radio frequency (RF) front-end module (FEM), comprising:
a first amplifier;
an integrated circuit coupled to the first amplifier, the integrated circuit comprising:
a first buffer amplifier coupled to the first amplifier;
a first variable attenuator coupled to the first buffer amplifier;
a first phase shifter or time delayer coupled to the first buffer amplifier;
a first memory configured to store a first gain calibration value and a first phase calibration value,
wherein the first gain calibration value controls an attenuation of the first variable attenuator and the first phase calibration value controls a phase shift of the first phase shifter or a time delay of the first time delayer;
a first interface configured to store the gain calibration value and the phase calibration value in the first memory;
an RF connection to a transceiver; and
an RF connection to an antenna.

2. The RF FEM of claim 1, wherein the first amplifier is a gallium arsenide or gallium nitride high-power amplifier.

3. The RF FEM of claim 1, wherein the first amplifier is a gallium arsenide or gallium nitride low-noise amplifier.

4. The RF FEM of claim 1, wherein the RF FEM is configured for use in a power combiner.

5. The RF FEM of claim 1, wherein the RF FEM is configured for use in a phased-array antenna.

6. The RF FEM of claim 1, further comprising a second interface configured to set a first desired gain and a first desired phase,
wherein the first gain calibration value is established such that a combined gain of the integrated circuit and the first amplifier is substantially equal to the first desired gain, and
wherein the first phase calibration value is established such that a combined phase of the integrated circuit and the first amplifier is substantially equal to the first desired phase.

7. The RF FEM of claim 1, wherein the RF FEM has a lower standard deviation of gain and a lower standard deviation of phase or time than a FEM that does not include the integrated circuit.

8. The RF FEM of claim 7, wherein the lower standard deviation of gain and the lower standard deviation of phase or time reduce a need for binning of FEMs or array-level calibration of a phased-array antenna.

9. The RF FEM of claim 1, further comprising a temperature sensor coupled to a second variable attenuator, such that a temperature of the RF FEM controls an attenuation of the second variable attenuator.

10. The RF FEM of claim 1, further comprising:
a package or housing;
a circuit board disposed within the package or housing, wherein the first amplifier is disposed on the circuit board;
a second amplifier disposed on the circuit board; and
a transmit/receive switch selectably connecting the RF connection to the transceiver and the RF connection to the antenna through either the first amplifier or the second amplifier,
wherein the integrated circuit further comprises:
a second buffer amplifier coupled to the second amplifier;
a second variable attenuator coupled to the second buffer amplifier;
a second phase shifter or time delayer coupled to the second buffer amplifier; and
a second memory configured to store a second gain calibration value and a second phase calibration value,
wherein the second gain calibration value controls an attenuation of the second variable attenuator and the second phase calibration value controls a phase shift of the second phase shifter or a time delay of second first time delayer,
wherein the second gain calibration value is established such that a second combined gain of the integrated circuit and the second amplifier is substantially a second desired gain, and
wherein the second phase calibration value is established such that a second combined phase of the integrated circuit and the second amplifier is substantially a second desired phase.

11. A phased array antenna or power combiner comprising:
a radio frequency (RF) front-end module (FEM), comprising:
a first amplifier;
an integrated circuit coupled to the first amplifier, the integrated circuit comprising:
a first buffer amplifier coupled to the first amplifier;
a first variable attenuator coupled to the first buffer amplifier;
a first phase shifter or time delayer coupled to the first buffer amplifier;
a first memory configured to store a first gain calibration value and a first phase calibration value,
wherein the first gain calibration value controls an attenuation of the first variable attenuator and the first phase calibration value controls a phase shift of the first phase shifter or a time delay of the first time delayer;
a first interface configured to receive a command to set the gain calibration value and the phase calibration value in the first memory;
an RF connection to a transceiver; and
an RF connection to an antenna.

12. The phased array antenna or power combiner of claim 11, further comprising a second interface configured to set a first desired gain and a first desired phase,
wherein the first gain calibration value is established such that a combined gain of the integrated circuit and the first amplifier is substantially the first desired gain, and
wherein the first phase calibration value is established such that a combined phase of the integrated circuit and the first amplifier is substantially the first desired phase.

13. The phased array antenna or power combiner of claim 11, wherein the first amplifier is a gallium arsenide or gallium nitride amplifier high-power amplifier or a gallium arsenide or gallium nitride amplifier low-noise amplifier.

14. The phased array antenna or power combiner of claim 11, wherein the RF FEM has a lower standard deviation of gain and a lower standard deviation of phase or time than a FEM that does not include the integrated circuit.

15. The phased array antenna or power combiner of claim 14, wherein the lower standard deviation of gain and the lower standard deviation of phase or time reduce a need for binning of FEMs or array-level calibration.

16. The phased array antenna or power combiner of claim 11, further comprising:
a package or housing;
a circuit board disposed within the package or housing, wherein the first amplifier is disposed on the circuit board;
a second amplifier disposed on the circuit board; and
a transmit/receive switch selectably connecting the RF connection to the transceiver and the RF connection to the antenna through either the first amplifier or the second amplifier,
wherein the integrated circuit further comprises:
a second buffer amplifier coupled to the second amplifier;
a second variable attenuator coupled to the second buffer amplifier;
a second phase shifter or time delayer coupled to the second buffer amplifier; and
a second memory storing a second gain calibration value and a second phase calibration value,
wherein the second gain calibration value controls an attenuation of the second variable attenuator and the second phase calibration value controls a phase shift of the second phase shifter or a time delay of second first time delayer,
wherein the second gain calibration value is established such that a second combined gain of the integrated circuit and the second amplifier is substantially a second desired gain, and
wherein the second phase calibration value is established such that a second combined phase of the integrated circuit and the second amplifier is substantially a second desired phase.

17. A method for providing a calibrated radio frequency (RF) front-end module (FEM), the method comprising:
providing a radio frequency (RF) front-end module (FEM), comprising:
a package or housing;
a circuit board disposed within the package or housing;
a first amplifier disposed on the circuit board;
a silicon integrated circuit disposed on the circuit board and comprising:
a first buffer amplifier coupled to the first amplifier;
a first variable attenuator coupled to the first buffer amplifier;
a first phase shifter or time delayer coupled to the first buffer amplifier;
a first memory;
an RF connection to a transceiver; and
an RF connection to an antenna;
with a first serial parallel interface (SPI) disposed on the silicon integrated circuit, controlling a commanded gain and commanded phase or time of the RF FEM;
with a measuring device, measuring an output gain and an output phase or time of the RF FEM; and
with a first one-time programming (OTP) interface disposed on the silicon integrated circuit, based on the commanded gain and commanded phase or time and the output gain and output phase or time, storing into the first memory:
a first gain calibration value and a first phase calibration value,
wherein the first gain calibration value controls an attenuation of the first variable attenuator and the first phase calibration value controls a phase shift of the first phase shifter or a time delay of the first time delayer,
wherein the first gain calibration value is based on the output gain, and
wherein the first phase calibration value is based on the output phase or time.

18. The method of claim 17, wherein the first amplifier is a gallium arsenide or gallium nitride high-power amplifier.

19. The method of claim 17, wherein the first amplifier is a gallium arsenide or gallium nitride low-noise amplifier.

20. The method of claim 17, further comprising:
providing:
a second amplifier disposed on the circuit board; and
a transmit/receive switch selectably connecting the RF connection to the transceiver and the RF connection to the antenna through either the first amplifier or the second amplifier,
wherein the silicon integrated circuit further comprises:
a second buffer amplifier coupled to the second amplifier;
a second variable attenuator coupled to the second buffer amplifier;
a second phase shifter or time delayer coupled to the second buffer amplifier; and
a second memory; and
with a second serial parallel interface (SPI) disposed on the silicon integrated circuit, controlling a second commanded gain and second commanded phase or time of the RF FEM;
with a second measuring device, measuring a second output gain and second output phase or time of the RF FEM; and
with a second one-time programming (OTP) interface disposed on the silicon integrated circuit, based on the second commanded gain and second commanded phase or time and the second output gain and second output phase or time, storing into the second memory:
a second gain calibration value and a second phase calibration value,
wherein the second gain calibration value controls an attenuation of the second variable attenuator and the second phase calibration value controls a phase shift of the second phase shifter or a time delay of the second time delayer,
wherein the second gain calibration value is based on the second output gain, and
wherein the second phase calibration value is based on the second output phase or time.
